(19) United States
(12) Patent Application Publication
(10) Pub. No.: US 2022/0247432 A1
(43) Pub. Date: Aug. 4, 2022

(54) CROSS ANTENNA CONFIGURATION IN FREQUENCY DIVISION DUPLEX (FDD) DUAL-BAND RADIO

(71) Applicant: TELEFONAKTIEBOLAGET LM ERICSSON (PUBL), STOCKHOLM (SE)

(72) Inventors: Ming Li, STOCKHOLM (SE); Youping Su, TÄBY (SE)

(21) Appl. No.: 17/624,772

(22) PCT Filed: Jul. 3, 2020
(86) PCT No.: PCT/IB2020/056301

§ 371 Date: Jan. 4, 2022

(30) Foreign Application Priority Data
Jul. 4, 2019 (CN) PCT/CN2019/094754

(51) Int. Cl. H04B 1/00; H04L 5/14

(52) U.S. Cl. CPC H04B 1/0064; H04B 1/18; H04L 5/14

(57) ABSTRACT

A multi-band radio, comprising a first antenna; a second antenna that is physically separate from the first antenna; one or more transmitters configured to: transmit a first transmit signal in a first transmit frequency band via the first antenna; and transmit a second transmit signal in a second transmit frequency band via the first antenna; and one or more receivers configured to: receive a first receive signal in a first receive frequency band via the second antenna; and receive a second receive signal in a second receive frequency band via the second antenna.

### RELATED APPLICATIONS

This application claims the benefit of International Patent Application No. PCT/CN2019/094754, filed Jul. 4, 2019, the disclosure of which is hereby incorporated herein by reference in its entirety.

### TECHNICAL FIELD

This application is generally directed to the field of telecommunications. More particularly, this application is directed to the field of antenna configurations for telecommunications.

### BACKGROUND

The present disclosure relates generally to a feature realization and method for implementation of wireless communication in a frequency division duplex (FDD) multi-band radio. Radio frequency (RF) technology is now mature enough to allow support of multiple simultaneous bands for transmission and/or reception through a common radio. A radio supporting multiple bands can be referred to as a multi-band (MB) radio. Customer demand for so-called MB radio is expected to increase to realize flexible configurations and applications. An important feature of an MB radio is to support dynamic power sharing between different bands and hence allow operators more flexibility in network deployment. From a site engineering point of view, an MB radio can reduce insertion loss for the antenna sharing multi-band scenario because no combiner is needed.

For MB radio, there are various possible structures based on combinations of different transmitter and receiver implementations as well as mapping of transceivers (e.g., radio units) to antenna ports in different ways. FIGS. 1A and 1B illustrate two traditional cases of mapping a two-band (2-band) FDD radio (for example, band Bx, including transmit band Bx1 and receive band Bx2, and band By, including transmit band By1 and receive band By2) into two antennas or a single antenna, respectively. Case 1, depicted in FIG. 1A, is an MB radio with two separate antennas, one antenna for transmitting on a first transmitting (TX) band (denoted as Bx1 TX) and receiving on a first receiving (RX) band (denoted as Bx2 RX) and another antenna for transmitting on a second TX band (denoted as By1 TX) and receiving on a second RX band (denoted as By2 RX). Case 2, depicted in FIG. 1B, is an MB radio with a common, shared antenna for all transmitting and receiving bands.

Problems with Existing Solutions

There currently exist certain challenge(s) in preventing signals transmitted in different frequency bands of an MB radio from degrading signal reception sensitivity in the MB radio. Receiver (RX) sensitivity is an important parameter in determining the overall performance of a communication system; RX sensitivity translates directly into communication distance and reliability. For an FDD radio, RX sensitivity degradation due to an FDD radio's own transmitter (TX) signal is very important because RX sensitivity dominates cell range and throughput. For an FDD radio capable of multi-band operation, RX sensitivity degradation due to the MB radio's own TX signal could be much more severe than single-band FDD radio operation. First, RX sensitivity of one band will be degraded by an MB radio's own TX signal on the one band and by TX signals on other bands of the MB radio. Second, the MB radio TX signal will be wider, and the TX intermodulation products will be worse in an FDD radio because of the wider digital pre-distortion (DPD) linearization band width and an increase of the intermodulation products hitting the receiver band.

Problems of case 1, due to interference paths shown in FIG. 2A, are explained by illustrations in FIG. 2B:
1. A transmit (TX) carrier transmitted from the same antenna as the receive (RX) carrier is received will block the MB radio's own receiver as strong interference. For example, the TX carrier in TX band Bx1 TX, even though it is outside of RX band Bx2 RX, will block the MB radio's own receiver for the RX band Bx2 RX as strong interference. An RX filter must attenuate the TX carrier in the TX band Bx1 TX to mitigate the RX sensitivity degradation for the MB radio's own receiver for the RX band Bx2 RX. Likewise, the TX carrier in TX band By1 TX, even though it is outside of the RX band By2 RX, will block the MB radio's own receiver for the RX band By2 RX as strong interference. An RX filter must attenuate the TX carrier in the TX band By1 TX to mitigate the RX sensitivity degradation for the MB radio's own receiver for the RX band By2 RX.
2. Bx or By Intra-band active intermodulation (AIM) hits the MB radio's own RX operating bands. A TX filter must attenuate AIM below the RX noise floor at the MB radio's own RX operating bands.
3. Bx or By Intra-band passive intermodulation (PIM) hits the MB radio's own RX operating bands. Avoiding the PIM results in increased cost for TX filter, connector, cable, and antenna, and puts limitations on carrier setup.

To avoid the interference paths of the first case (i.e., to support N bands), the number of antennas is 2*N (i.e., a dedicated antenna for each receiver and each transmitter).

Problems of case 2, due to interference paths shown in FIG. 3A, are explained by illustrations in FIG. 3B:
1. TX carriers of both transmit bands (Bx1 TX and By1 TX) may block the MB radio's own receiver as strong interference. An RX filter may be used to attenuate the TX carriers to mitigate the RX sensitivity degradation.
2. Bx or By Intra-band AIM hits the RX operating band. A TX filter may attenuate AIM below the RX noise floor at the MB radio's own RX operating bands.
3. Bx or By Intra-band PIM hits the MB radio's own RX operating band. Avoiding the PIM results in increased cost for TX filter, connector, cable, and antenna, and puts limitations on carrier setup.
4. Bx and By Inter-band AIM hits the RX operating band. A TX filter may attenuate AIM below the RX noise floor at the MB radio's own RX operating bands.
5. Bx and By Inter-band PIM hits the MB radio's own RX operating band. Avoiding the PIM results in increased cost for TX filter, connector, cable, and antenna, and puts limitations on carrier setup.

### SUMMARY

Some embodiments of the present disclosure include the following:

An embodiment of the present disclosure may include a multi-band radio, which includes a first antenna, a second antenna that is physically separate from the first antenna, one or more transmitters configured to transmit a first transmit signal in a first transmit frequency band via the first antenna; and transmit a second transmit signal in a second transmit frequency band via the first antenna; and one or more receivers configured to receive a first receive signal in a first receive frequency band via the second antenna and receive a second receive signal in a second receive frequency band via the second antenna.

Intermodulation distortion components of the first transmit signal and the second transmit signal that fall within either the first receive frequency band or the second receive frequency band may be attenuated at the second antenna due to physical separation between the first antenna and the second antenna. The one or more receivers may include a first receive filter configured to filter signals from the second antenna that fall outside of the first receive frequency band to pass the first receive signal in the first receive frequency band; and a second receive filter configured to filter the signals from the second antenna that fall outside of the second receive frequency band to pass the second receive signal in the second receive frequency band. The one or more transmitters may each be coupled to the first antenna. The one or more receivers may each be coupled to the second antenna. The multi-band radio may operate in a frequency division duplex, FDD, mode, and leakage of the intermodulation distortion components that fall within either the first receive frequency band or the second receive frequency band may be attenuated prior to reception at the second antenna due to physical separation between the first antenna and the second antenna. The multi-band radio may be included in a User Equipment, UE. The multi-band radio may be included in a base station. The first transmit signal in the first transmit frequency band and the second transmit signal in the second transmit frequency band may be attenuated prior to reception at the second antenna due to physical separation between the first antenna and the second antenna.

Some embodiments include a method implemented in a multi-band radio. The method may include transmitting a first transmit signal in a first transmit frequency band via a first antenna; transmitting a second transmit signal in a second transmit frequency band via the first antenna; receiving a first receive signal in a first receive frequency band via a second antenna, the second antenna being physically separate from the first antenna; and receiving a second receive signal in a second receive frequency band via the second antenna. Some embodiments may include intermodulation distortion components of the first transmit signal and the second transmit signal that fall within either the first receive frequency band or the second receive frequency band are attenuated at the second antenna due to physical separation between the first antenna and the second antenna. The first transmit signal in the first transmit frequency band and the second transmit signal in the second transmit frequency band may be attenuated prior to reception at the second antenna due to physical separation between the first antenna and the second antenna.

Some additional embodiments may include a user equipment, UE. The UE may include a processing device and a transceiver system. The transceiver system may include a first antenna; a second antenna that is physically separate from the first antenna; one or more transmitters configured to transmit a first transmit signal in a first transmit frequency band via the first antenna and transmit a second transmit signal in a second transmit frequency band via the first antenna; and one or more receivers configured to receive a first receive signal in a first receive frequency band via the second antenna and receive a second receive signal in a second receive frequency band via the second antenna.

Some embodiments may include a method implemented in a User Equipment, UE, the method including transmitting a first transmit signal in a first transmit frequency band via a first antenna of the UE; transmitting a second transmit signal in a second transmit frequency band via the first antenna; receiving a first receive signal in a first receive frequency band via a second antenna of the UE, the second antenna being physically separate from the first antenna; and receiving a second receive signal in a second receive frequency band via the second antenna.

Some additional embodiments may include a base station, having: a processing device; and a transceiver system. The transceiver system may include a first antenna; a second antenna that is physically separate from the first antenna; one or more transmitters configured to transmit a first transmit signal in a first transmit frequency band via the first antenna and transmit a second transmit signal in a second transmit frequency band via the first antenna; and one or more receivers configured to receive a first receive signal in a first receive frequency band via the second antenna and receive a second receive signal in a second receive frequency band via the second antenna.

Some additional embodiments may include, a method implemented in a base station, the method including steps of: transmitting a first transmit signal in a first transmit frequency band via a first antenna of the base station; transmitting a second transmit signal in a second transmit frequency band via the first antenna; receiving a first receive signal in a first receive frequency band via a second antenna of the base station, the second antenna being physically separate from the first antenna; and receiving a second receive signal in a second receive frequency band via the second antenna.

### BRIEF DESCRIPTION OF THE DRAWINGS

The present disclosure includes the following illustrative drawings:

FIG. 1A is a schematic diagram of a multi-band radio two separate antennas.

FIG. 1B is a schematic diagram of a multi-band radio with a common, shared antenna.

FIG. 2A is a schematic diagram of the multi-band radio of FIG. 1A further depicting interference paths.

FIG. 2B illustrates interference as may occur in the multi-band radio of FIG. 1A.

FIG. 3A is a schematic diagram of the multi-band radio of FIG. 1B further depicting interference paths.

FIG. 3B illustrates interference as may occur in the multi-band radio of FIG. 1B.

FIG. 4 illustrates a cellular communications system in which embodiments of the present disclosure may be implemented.

FIG. 5 is a schematic diagram of a 2-band FDD radio configuration according to aspects of the present disclosure.

FIG. 6 illustrates, from a filter rejection point of view, a relaxation difference in the filter requirement of the traditional antenna configuration and the cross antenna configuration of FIG. 5.

FIG. 7 illustrates a 2 TX 2-band, RX 2-band radio cross antenna in which PIM generation source component requirements can be relaxed, according to aspects of the pressure disclosure.

FIG. 8 is a flowchart illustrating an exemplary method implemented in an MB radio, according to some embodiments of the present disclosure.

FIG. 9 is a schematic block diagram of a radio access node 900 according to some embodiments of the present disclosure.

FIG. 10 is a schematic block diagram that illustrates a virtualized embodiment of the radio access node 900 according to some embodiments of the present disclosure.

FIG. 11 is a schematic block diagram of the radio access node 900 according to some other embodiments of the present disclosure.

FIG. 12 is a schematic block diagram of a UE 1200 according to some embodiments of the present disclosure.

FIG. 13 is a schematic block diagram of the UE 1200 according to some other embodiments of the present disclosure.

The figures may be best understood by reference to the following detailed description.

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc., are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Certain aspects of the present disclosure and their embodiments may provide solutions to the aforementioned or other challenges.

A solution proposed herein includes an antenna and filter configuration for FDD MB radio which can mitigate RX sensitivity degradation due to the MB radio's own TX signals.

Below is a list of examples of approaches for mitigating TX to RX interference:
1. For blocking: One solution is to have more than 100 decibel (dB) rejection at TX operating band for RX cavity filter. But, high rejection may result in high cost and additional cavity size.
2. For AIM hitting RX band:
   A first solution is to have more than 100 dB rejection at RX operating band for TX cavity filter, but high rejection means high cost and additional cavity size.
   A second solution is to have linear power amplifier (PA), but linear PA means low efficiency.
   A third solution is to have wide band and super performance digital pre-distortion (DPD), but such DPD is power hungry and costly.
3. For PIM: A solution is to have high cost, bulky, low PIM TX cavity filter, cable, connector, and antenna.

Solutions proposed herein may include a new filter and antenna cross configuration for MB radio which mitigates the RX sensitivity degradation that is due to the MB radio's own transmitter. A solution is to use one antenna for all bands of the transmitter and a separate antenna for all bands of the receiver.

There are, proposed herein, various embodiments which address one or more of the issues disclosed herein.

Certain embodiments may provide one or more of the following technical advantage(s). The solution proposed herein may be compatible with an MB base station (BS) architecture and/or an MB user equipment (UE). Employing solutions proposed herein, the TX to RX blocking and interference may be mitigated or eliminated.

Some of the embodiments contemplated herein will now be described more fully with reference to the accompanying drawings. However, other embodiments are contained within the scope of the subject matter disclosed herein, such that the disclosed subject matter should not be construed as limited to only the embodiments set forth herein. Rather, these embodiments are provided by way of example to convey the scope of the subject matter to those skilled in the art.

Radio Node: As used herein, a “radio node” is either a radio access node or a wireless device.

Radio Access Node: As used herein, a “radio access node” or “radio network node” is any node in a radio access network of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), and a relay node.

Core Network Node: As used herein, a “core network node” is any type of node in a core network or any node that implements a core network function. Some examples of a core network node include, e.g., a Mobility Management Entity (MME), a Packet Data Network Gateway (PGW), a Service Capability Exposure Function (SCEF), a Home Subscriber Server (HSS), or the like. Some other examples of a core network node include a node implementing a Access and Mobility Function (AMF), a UPF, a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Wireless Device: As used herein, a “wireless device” is any type of device that has access to (i.e., is served by) a cellular communications network by wirelessly transmitting and/or receiving signals to a radio access node(s). Some examples of a wireless device include, but are not limited to, a User Equipment device (UE) in a 3GPP network and a Machine Type Communication (MTC) device.

Network Node: As used herein, a “network node” is any node that is either part of the radio access network or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

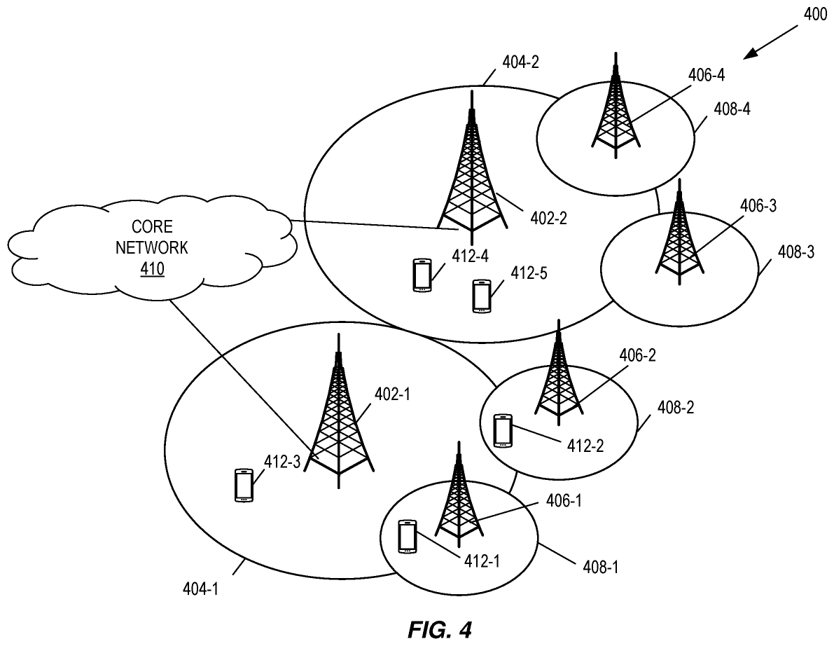

FIG. 4 illustrates one example of a cellular communications system 400 in which embodiments of the present disclosure may be implemented. In the embodiments described herein, the cellular communications system 400 is a 5G system (5GS) including a NR radio access node (RAN) or an Evolved Packet System (EPS) including a LTE RAN. In this example, the RAN includes base stations 402-1 and 402-2, which in LTE are referred to as eNBs and in 5G NR are referred to as gNBs, controlling corresponding (macro) cells 404-1 and 404-2. The base stations 402-1 and 402-2 are generally referred to herein collectively as base stations 402 and individually as base station 402. Likewise, the (macro) cells 404-1 and 404-2 are generally referred to herein collectively as (macro) cells 404 and individually as (macro) cell 404. The RAN may also include a number of low-power nodes 406-1 through 406-4 controlling corresponding small cells 408-1 through 408-4. The low-power nodes 406-1 through 406-4 can be small base stations (such as pico or femto base stations) or Remote Radio Heads (RRHs), or the like. Notably, while not illustrated, one or more of the small cells 408-1 through 408-4 may alternatively be provided by the base stations 402. The low-power nodes 406-1 through 406-4 are generally referred to herein collectively as low-power nodes 406 and individually as a low power node 406. Likewise, the small cells 408-1 through 408-4 are generally referred to herein collectively as small cells 408 and individually as a small cell 408. The cellular communications system 400 also includes a core network 410, which in the 5G system is referred to as the 5G core (5GC). The base stations 402 (and optionally the low-power nodes 406) are connected to the core network 410.

The base stations 402 and the low-power nodes 406 provide service to wireless devices 412-1 through 412-5 in the corresponding cells 404 and 408. The wireless devices 412-1 through 412-5 are generally referred to herein collectively as wireless devices 412 and individually as wireless device 412. The wireless devices 412 are also sometimes referred to herein as UEs. The wireless devices 412 and/or the base stations 402 herein may be multi-band (MB) radio devices with a cross antenna configuration for wirelessly communicating over multiple frequency bands.

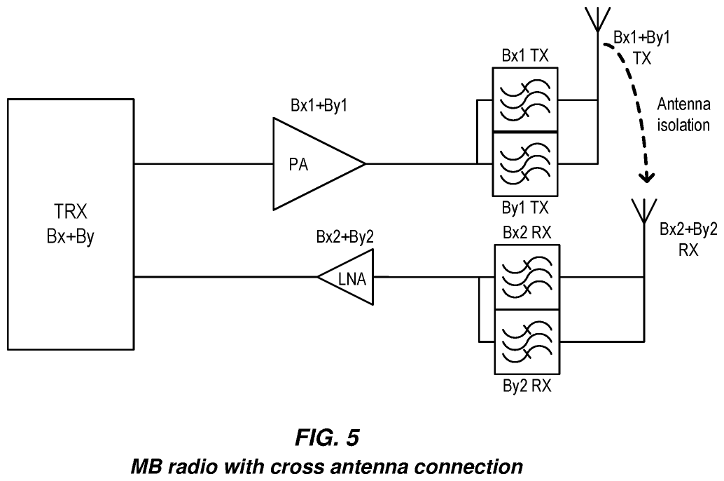

As an example, a cross antenna configuration for the MB radio wireless device 412 is depicted in FIG. 5. The wireless device 412 uses one antenna for transmission of two or more frequency bands (e.g., all TX frequency bands supported by the MB radio wireless device), and uses a separate antenna for reception of two or more frequency bands (e.g., all RX frequency bands supported by the MB radio wireless device). By employing a TX antenna and a separate RX antenna in this manner, a TX signal will not be directly coupled to the receiver. The TX signal will be attenuated by the natural antenna space isolation before hitting the receiver. In addition, the intra-band, inter-band AIM and PIM will be attenuated by this space isolation before hitting the receiver.

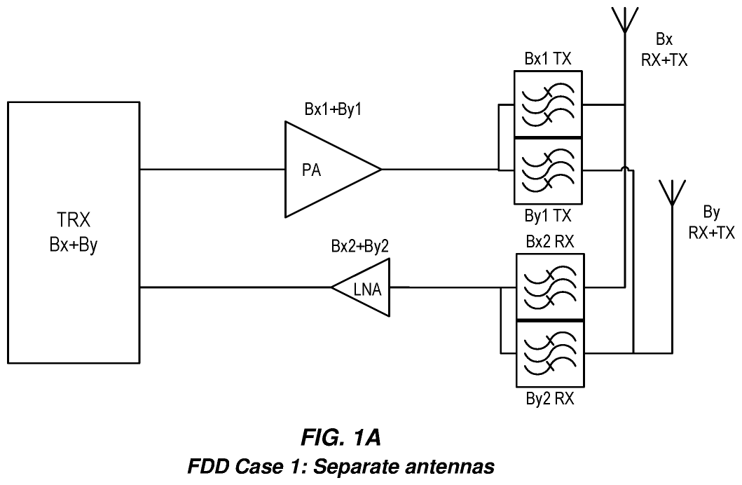

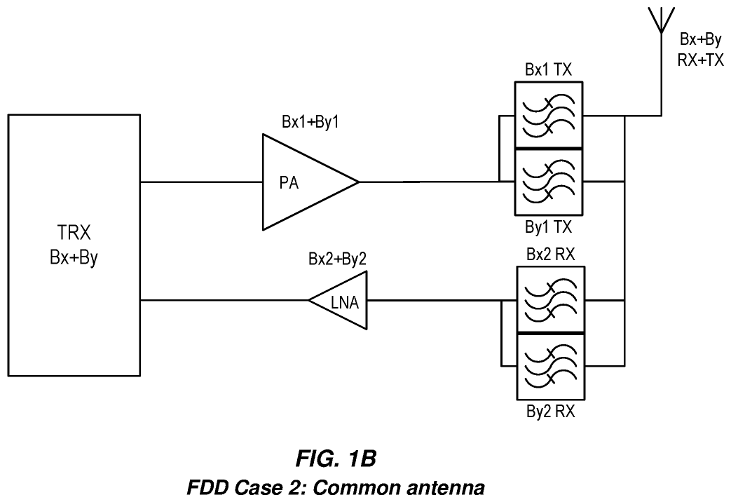

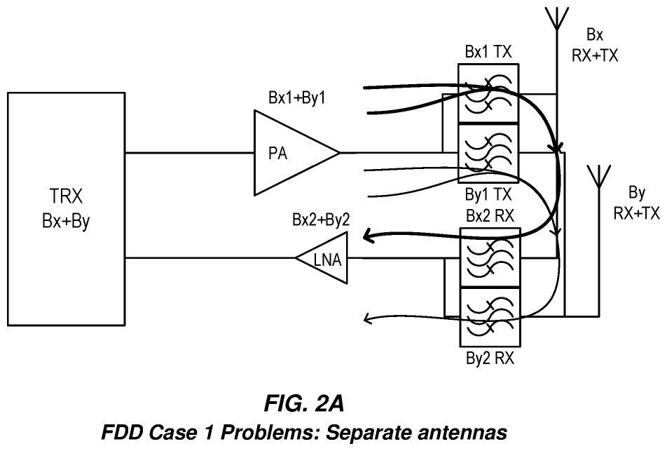

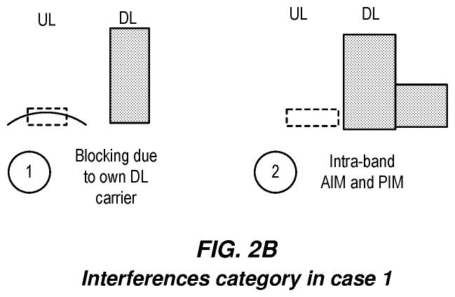

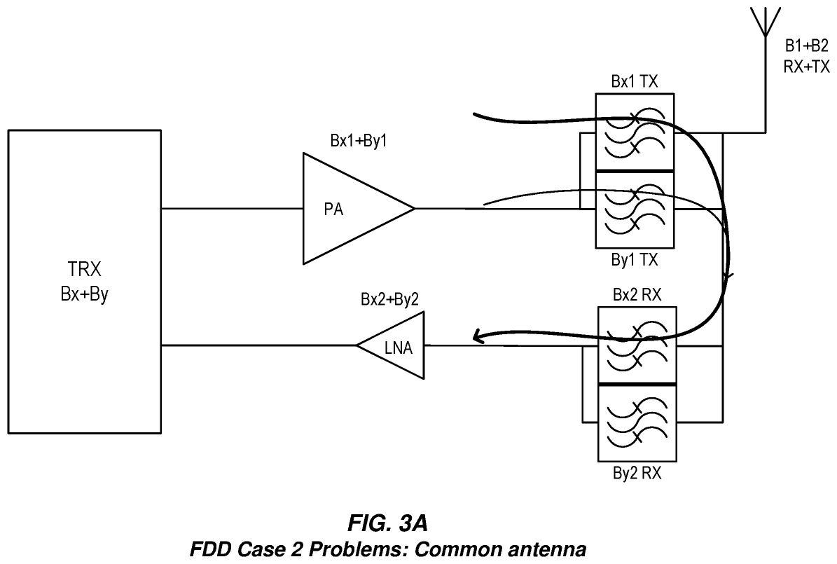

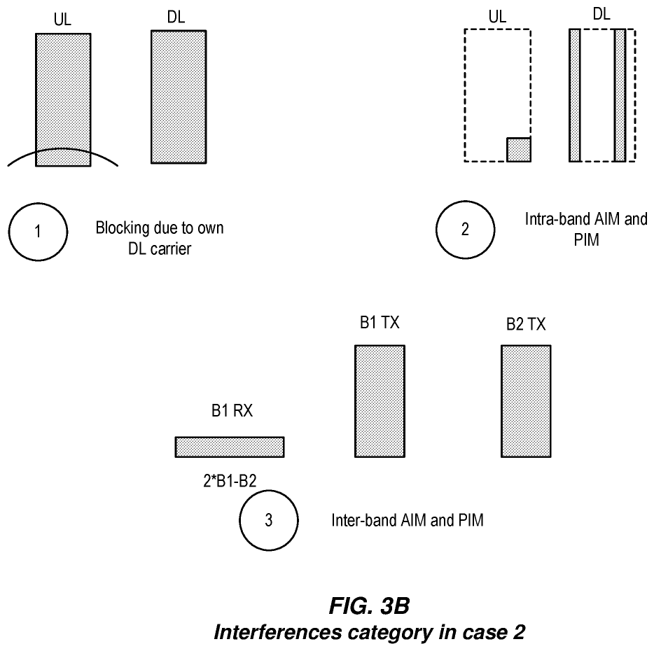

In other words, the first case in FIG. 1A and the second case in FIG. 1B are MB radios with an antenna directly coupled to a transmitter for transmission of signals in a first frequency band, and directly coupled to a receiver for reception of signals in a second frequency band, according to FDD methods. In this regard, the transmission strength of a signal provided to the antenna by the transmitter is also directly coupled to the receiver. The receiver includes a filter to exclude the signals that are received at this transmission strength due to the receiver being directly coupled to the transmitter, which requires filter components that are large and expensive. Production testing of such filters in an MB radio requires time and increases cost.

In contrast, in the wireless device 412 in FIG. 4, the receiver is not directly coupled to the same antenna as the transmitter, so the receiver does not receive a signal at the transmission strength of the signal provided to the first antenna by the transmitter. Rather, due to the natural antenna space isolation provided by the wireless interface between the first antenna and the second antenna, the signal received in the receiver on the second antenna has a strength that is 25 decibels (dB) lower than the strength of the signal transmitted on the first antenna. Consequently, the filter components needed in the receiver are smaller and less expensive and do not require long and expensive production testing.

FIG. 5 shows a 2-band FDD radio configuration. The principle is the same for an FDD radio having more than 2 bands. For example, for a 4-band FDD radio, the transmitters of all 4 transmission bands use one antenna, and a separate antenna is used for the receivers of all 4 reception bands.

Assuming 25 dB isolation between the two antennas:
1. A receiver in the Bx2 RX band just needs to handle the TX signal from the transmit antenna in the Bx1 band, which is reduced by 25 dB due to antenna isolation. Therefore, it is possible to relax the RX filter rejection by 25 dB at the TX band.
2. The TX AIM hitting a corresponding RX operating band can be reduced by 25 dB.
3. The TX PIM hitting a corresponding RX operating band can be reduced by 25 dB.

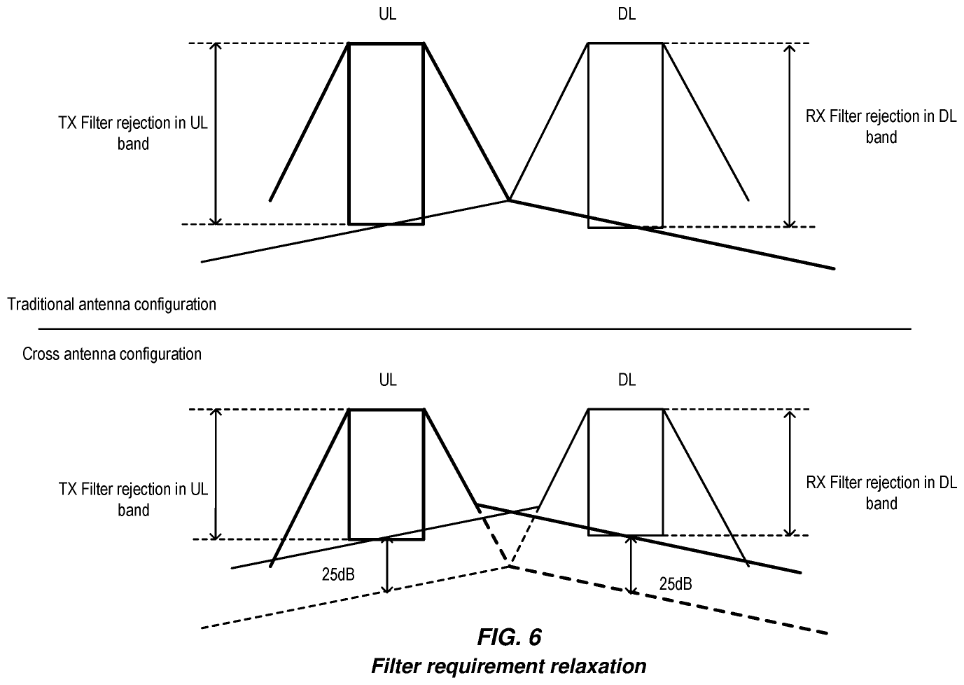

FIG. 6 illustrates, from a filter rejection point of view, a relaxation difference in the filter requirement of the traditional antenna configuration and the cross antenna configuration disclosed herein.

As discussed above, both of the RX filter rejection needed at the TX band and the TX filter rejection needed at the RX band can be relaxed by 25 dB. The filter rejection relaxation allows a significant difference from previous filter design, especially for some 3GPP FDD bands, in which a distance between a TX band and an RX band is only several megahertz (MHz) or a few dozen MHz. The difference can save a high portion of the entire filter cost, and the size can be decreased by removing several resonators. Subsequently, due to filter rejection relaxation, filter production test time and cost can also be saved.

Because a TX signal will be attenuated by 25 dB before hitting a RX filter, the power handled by the RX filter is 25 dB lower, which will make it possible to use a small resonator for the RX filter, which means a smaller size, less weight, and less cost.

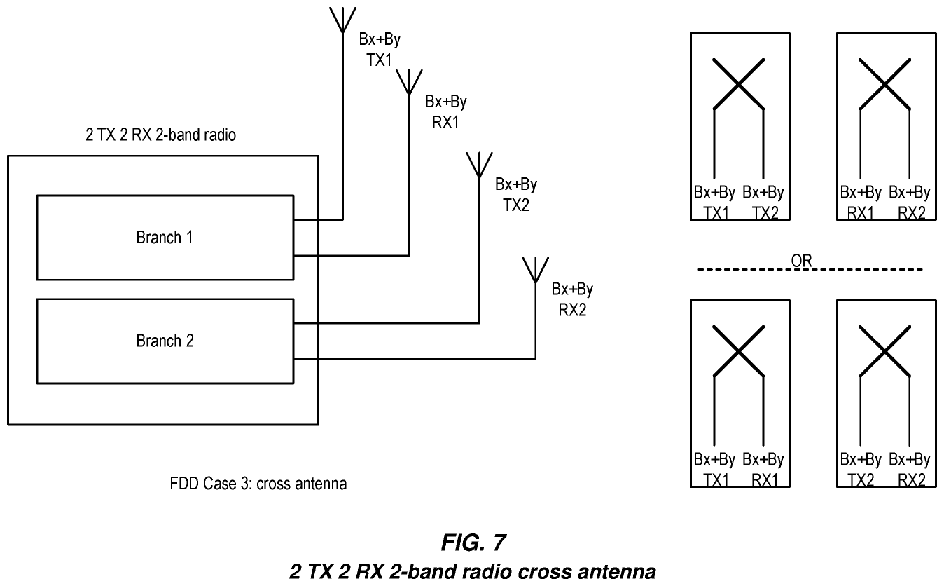

FIG. 7 illustrates a 2 TX 2-band, RX 2-band radio cross antenna in which PIM generation source component requirements can be relaxed, which means that the cost decreases, and BS field performance is not sensitive to site installation quality. The illustrated configuration may improve robustness.

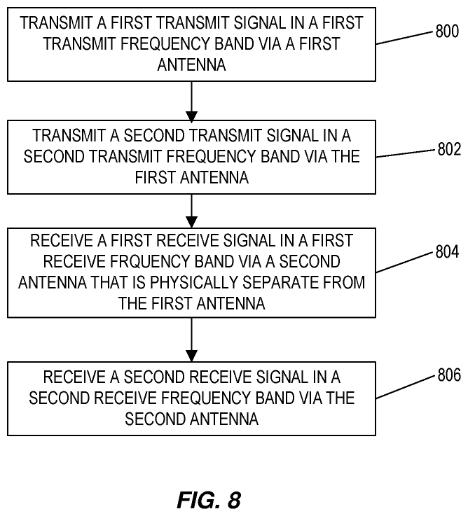

FIG. 8 is a flowchart illustrating an exemplary method implemented in an MB radio, according to some embodiments of the present disclosure.

The MB radio generates a first transmit signal. This generation includes generation of the first transmit signal at baseband or Intermediate Frequency (IF), upconversion to a desired carrier frequency in a first transmit frequency band, and amplification. As described above, due to intermodulation distortion, once upconverted, the first transmit signal includes undesired intermodulation distortion components at frequencies other than the desired carrier frequency for the first transmit frequency band. In this example, at least one of the intermodulation distortion components falls within either a first receive frequency band of the MB radio or a second receive frequency band of the MB radio. Therefore, the intermodulation distortion components cause interference with one of the first receive frequency band and the second receive frequency band. The signal on the desired carrier frequency of the first transmit frequency band, which is outside the first receive frequency band and the second receive frequency band, may block the first receive frequency band or the second receive frequency band (e.g., by desensitizing the receiver amplifier).

The MB radio generates a second transmit signal. This generation includes generation of the second transmit signal at baseband or IF, upconversion to a desired carrier frequency in a second transmit frequency band, and amplification. As described above, due to intermodulation distortion, once upconverted, the second transmit signal includes undesired intermodulation distortion components at frequencies other than the desired carrier frequency for the second transmit band. In this example, at least one of the intermodulation distortion components falls within either the first receive frequency band of the MB radio or the second receive frequency band of the MB radio. Therefore, the intermodulation distortion components cause interference with one of the first receive frequency band and the second receive frequency band. The signal on the desired carrier frequency of the second transmit frequency band, which is outside the first receive frequency band and the second receive frequency band, may block the first receiver or the second receiver (e.g., by desensitizing the receiver amplifier).

The steps of one embodiment of the method of FIG. 8 are as follows. Step 800: The MB radio transmits, from a first antenna, the first transmit signal in the first transmit frequency band. Step 802: The MB radio also transmits, from the first antenna, the second transmit signal in the second transmit frequency band. While transmitting the first transmit signal and the second transmit signal, the MB radio also receives signals at a second antenna. Step 804: The MB radio receives signals including a first receive signal in a first receive frequency band via the second antenna, which is physically separate from the first antenna. Step 806: The MB radio receives signals including a second receive signal in a second receive frequency band at the second antenna. Other embodiments of the method of FIG. 8 may include additional or alternative operations as described herein and may include additional or alternative steps or operations before, after, or in between the enumerated steps. Some embodiments of the method of FIG. 8 may include a computer-readable storage medium having instructions thereon that cause a system including appropriate hardware to perform the steps shown in FIG. 8.

Other signals received at the second antenna include the first transmit signal in the first transmit frequency band, the second transmit signal in the second frequency band, and the undesired intermodulation distortion components generated outside of the first and second transmit frequency bands by the first and second transmitters. These other signals can cause blocking and interference of the first and second receive frequency bands. However, because the receivers are connected to the second antenna, and not directly coupled to either of the transmitters, these other signals are attenuated (e.g., by 25 dB due) due to the antenna to antenna isolation. Therefore, signals such as the intermodulation components that fall outside of the first and second receive frequency bands can be more easily filtered (i.e., attenuated or removed), which allows the receivers to be designed with smaller, less expensive filters. Typically, the transmit signals (i.e., the desired components of the transmit signals in the first and second transmit bands) are stronger signals that can desensitize the receiver amplifiers, causing reception by those receivers to be blocked even though the transmit signals are outside of the receive frequency bands. By using the cross antenna configuration disclosed herein, the (e.g., 25 dB) attenuation of these transmit signals due to the physical separation between the two antennas reduces the filtering requirements for protecting against those signals in both of the receivers.

The MB radio filters the signals received via the second antenna using a first receive filter for the first receive band to thereby provide a received signal for the first receive band. Likewise, the MB radio filters the signals received via the second antenna using a second receive filter for the second receive band to thereby provide a received signal for the second receive band.

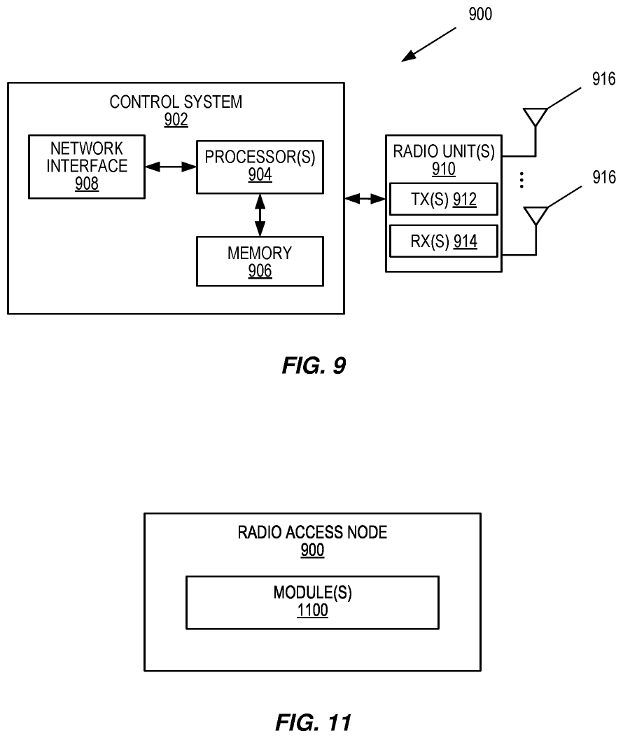

FIG. 9 is a schematic block diagram of a radio access node 900 according to some embodiments of the present disclosure. The radio access node 900 may be, for example, a base station 402 or 406. As illustrated, the radio access node 900 includes a control system 902 that includes one or more processors 904 (e.g., Central Processing Units (CPUs), Application Specific Integrated Circuits (ASICs), Field Programmable Gate Arrays (FPGAs), and/or the like), memory 906, and a network interface 908. The one or more processors 904 are also referred to herein as processing circuitry. In addition, the radio access node 900 includes one or more radio units 910 that each includes one or more transmitters 912 and one or more receivers 914 coupled to one or more antennas 916. The radio units 910 may be referred to or be part of radio interface circuitry. In some embodiments, the radio unit(s) 910 is external to the control system 902 and connected to the control system 902 via, e.g., a wired connection (e.g., an optical cable). However, in some other embodiments, the radio unit(s) 910 and potentially the antenna(s) 916 are integrated together with the control system 902. The one or more processors 904 operate to provide one or more functions of a radio access node 900 as described herein. In some embodiments, the function(s) are implemented in software that is stored, e.g., in the memory 906 and executed by the one or more processors 904.

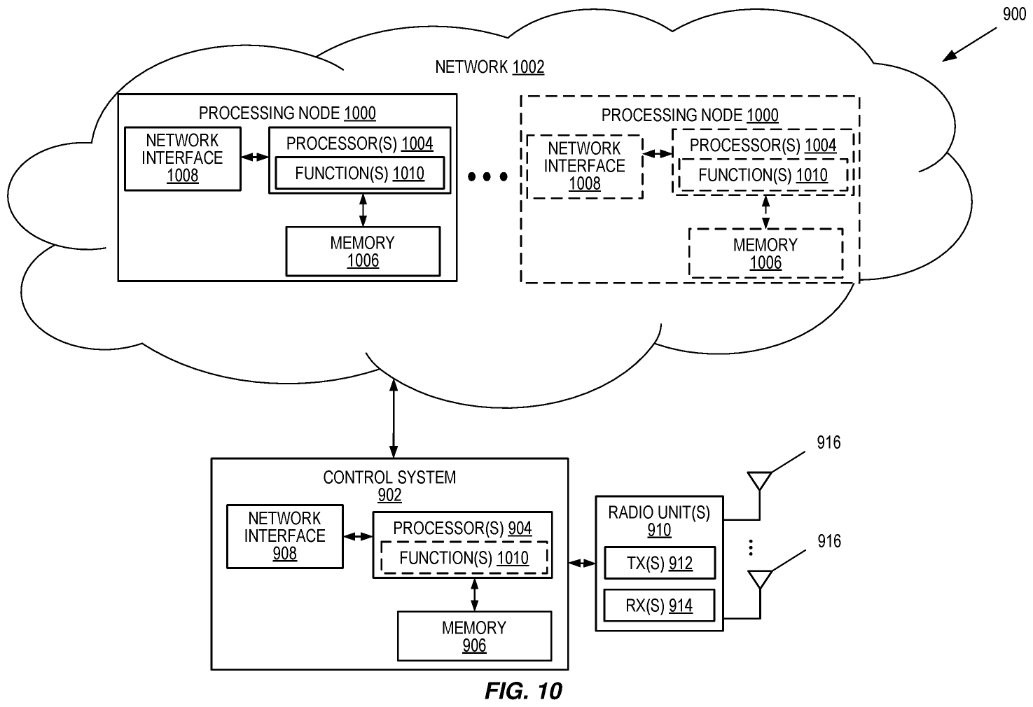

FIG. 10 is a schematic block diagram that illustrates a virtualized embodiment of the radio access node 900 according to some embodiments of the present disclosure. This discussion is equally applicable to other types of network nodes. Further, other types of network nodes may have similar virtualized architectures.

As used herein, a “virtualized” radio access node is an implementation of the radio access node 900 in which at least a portion of the functionality of the radio access node 900 is implemented as a virtual component(s) (e.g., via a virtual machine(s) executing on a physical processing node(s) in a network(s)). As illustrated, in this example, the radio access node 900 includes the control system 902 that includes the one or more processors 904 (e.g., CPUs, ASICs, FPGAs, and/or the like), the memory 906, and the network interface 908 and the one or more radio units 910 that each includes the one or more transmitters 912 and the one or more receivers 914 coupled to the one or more antennas 916, as described above. The control system 902 is connected to the radio unit(s) 910 via, for example, an optical cable or the like. The control system 902 is connected to one or more processing nodes 1000 coupled to or included as part of a network(s) 1002 via the network interface 908. Each processing node 1000 includes one or more processors 1004 (e.g., CPUs, ASICs, FPGAs, and/or the like), memory 1006, and a network interface 1008.

In this example, functions 1010 of the radio access node 900 described herein are implemented at the one or more processing nodes 1000 or distributed across the control system 902 and the one or more processing nodes 1000 in any desired manner. In some particular embodiments, some or all of the functions 1010 of the radio access node 900 described herein are implemented as virtual components executed by one or more virtual machines implemented in a virtual environment(s) hosted by the processing node(s) 1000. As will be appreciated by one of ordinary skill in the art, additional signaling or communication between the processing node(s) 1000 and the control system 902 is used in order to carry out at least some of the desired functions 1010. Notably, in some embodiments, the control system 902 may not be included, in which case the radio unit(s) 910 communicate directly with the processing node(s) 1000 via an appropriate network interface(s).

In some embodiments, a computer program including instructions which, when executed by at least one processor, causes the at least one processor to carry out the functionality of radio access node 900 or a node (e.g., a processing node 1000) implementing one or more of the functions 1010 of the radio access node 900 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 11 is a schematic block diagram of the radio access node 900 according to some other embodiments of the present disclosure. The radio access node 900 includes one or more modules 1100, each of which is implemented in software. The module(s) 1100 provide the functionality of the radio access node 900 described herein. This discussion is equally applicable to the processing node 1000 of FIG. 10 where the modules 1100 may be implemented at one of the processing nodes 1000 or distributed across multiple processing nodes 1000 and/or distributed across the processing node(s) 1000 and the control system 902.

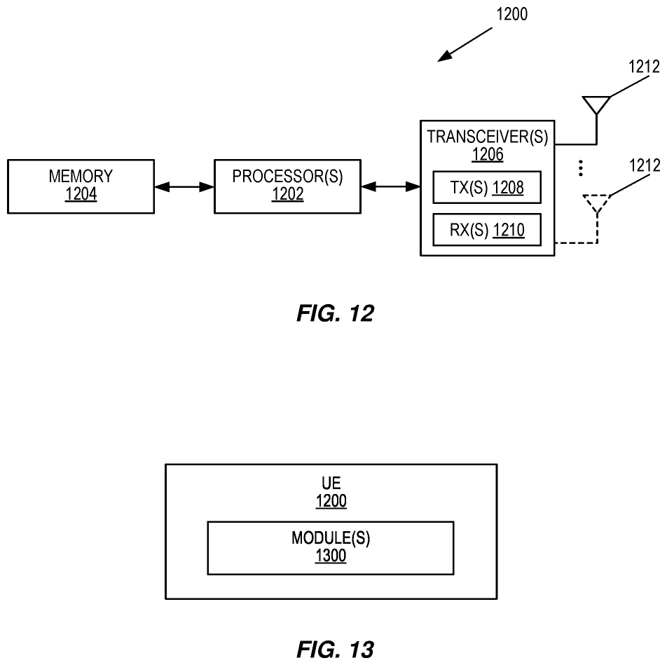

FIG. 12 is a schematic block diagram of a UE 1200 according to some embodiments of the present disclosure. As illustrated, the UE 1200 includes one or more processors 1202 (e.g., CPUs, ASICs, FPGAs, and/or the like), memory 1204, and one or more transceivers 1206 each including one or more transmitters 1208 and one or more receivers 1210 coupled to one or more antennas 1212 in a cross antenna configuration, as described above. The transceiver(s) 1206 includes radio-front end circuitry connected to the antenna(s) 1212 that is configured to condition signals communicated between the antenna(s) 1212 and the processor(s) 1202, as will be appreciated by one of ordinary skill in the art. The UE 1200 may be an MB radio employing a cross antenna configuration as disclosed herein to reduce the size and cost of filters therein, and also to reduce the cost and time needed for production testing. The processors 1202 are also referred to herein as processing circuitry. The transceivers 1206 are also referred to herein as radio circuitry. In some embodiments, the functionality of the UE 1200 described above may be fully or partially implemented in software that is, e.g., stored in the memory 1204 and executed by the processor(s) 1202. Note that the UE 1200 may include additional components not illustrated in FIG. 12 such as, e.g., one or more user interface components (e.g., an input/output interface including a display, buttons, a touch screen, a microphone, a speaker(s), and/or the like and/or any other components for allowing input of information into the UE 1200 and/or allowing output of information from the UE 1200), a power supply (e.g., a battery and associated power circuitry), etc.

In some embodiments, a computer program including instructions which, when executed by at least one processor, causes the at least one processor to carry out the functionality of the UE 1200 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 13 is a schematic block diagram of the UE 1200 according to some other embodiments of the present disclosure. The UE 1200 includes one or more modules 1300, each of which is implemented in software. The module(s) 1300 provide the functionality of the UE 1200 described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

1. A multi-band radio, comprising:
a first antenna;
a second antenna that is physically separate from the first antenna;
one or more transmitters configured to:
transmit a first transmit signal in a first transmit frequency band via the first antenna; and
transmit a second transmit signal in a second transmit frequency band via the first antenna; and
one or more receivers configured to:
receive a first receive signal in a first receive frequency band via the second antenna; and
receive a second receive signal in a second receive frequency band via the second antenna.

2. The multi-band radio of claim 1, wherein intermodulation distortion components of the first transmit signal and the second transmit signal that fall within either the first receive frequency band or the second receive frequency band are attenuated at the second antenna due to physical separation between the first antenna and the second antenna.

3. The multi-band radio of claim 1, wherein the one or more receivers comprise:
a first receive filter configured to filter signals from the second antenna that fall outside of the first receive frequency band to pass the first receive signal in the first receive frequency band; and
a second receive filter configured to filter the signals from the second antenna that fall outside of the second receive frequency band to pass the second receive signal in the second receive frequency band.

4. The multi-band radio of claim 1, wherein:
the one or more transmitters are each coupled to the first antenna; and
the one or more receivers are each coupled to the second antenna.

5. The multi-band radio of claim 2, wherein the multi-band radio operates in a frequency division duplex (FDD) mode, and leakage of the intermodulation distortion components that fall within either the first receive frequency band or the second receive frequency band are attenuated prior to reception at the second antenna due to physical separation between the first antenna and the second antenna.

6. The multi-band radio of claim 1, wherein the multi-band radio is comprised in a User Equipment (UE).

7. The multi-band radio of claim 1, wherein the multi-band radio is comprised in a base station.

8. The multi-band radio of claim 1, wherein:
the first transmit signal in the first transmit frequency band and the second transmit signal in the second transmit frequency band are attenuated prior to reception at the second antenna due to physical separation between the first antenna and the second antenna.

9. A method implemented in a multi-band radio, the method comprising:
transmitting a first transmit signal in a first transmit frequency band via a first antenna;
transmitting a second transmit signal in a second transmit frequency band via the first antenna;
receiving a first receive signal in a first receive frequency band via a second antenna, the second antenna being physically separate from the first antenna; and
receiving a second receive signal in a second receive frequency band via the second antenna.

10. The method of claim 9, wherein intermodulation distortion components of the first transmit signal and the second transmit signal that fall within either the first receive frequency band or the second receive frequency band are attenuated at the second antenna due to physical separation between the first antenna and the second antenna.

11. The method of claim 9 wherein:
the first transmit signal in the first transmit frequency band and the second transmit signal in the second transmit frequency band are attenuated prior to reception at the second antenna due to physical separation between the first antenna and the second antenna.

12. A user equipment (UE) comprising:
a processing device; and
a transceiver system including:
a first antenna;
a second antenna that is physically separate from the first antenna;
one or more transmitters configured to:
transmit a first transmit signal in a first transmit frequency band via the first antenna; and
transmit a second transmit signal in a second transmit frequency band via the first antenna; and
one or more receivers configured to:
receive a first receive signal in a first receive frequency band via the second antenna; and
receive a second receive signal in a second receive frequency band via the second antenna.

13-15. (canceled)

16. The UE of claim 12, wherein intermodulation distortion components of the first transmit signal and the second transmit signal that fall within either the first receive frequency band or the second receive frequency band are attenuated at the second antenna due to physical separation between the first antenna and the second antenna.

17. The UE of claim 16, wherein the UE operates in a frequency division duplex (FDD) mode, and leakage of the intermodulation distortion components that fall within either the first receive frequency band or the second receive frequency band are attenuated prior to reception at the second antenna due to physical separation between the first antenna and the second antenna.

18. The UE of claim 12, wherein the one or more receivers comprise:
a first receive filter configured to filter signals from the second antenna that fall outside of the first receive frequency band to pass the first receive signal in the first receive frequency band; and
a second receive filter configured to filter the signals from the second antenna that fall outside of the second receive frequency band to pass the second receive signal in the second receive frequency band.

19. The UE of claim 12, wherein:
the one or more transmitters are each coupled to the first antenna; and
the one or more receivers are each coupled to the second antenna.

20. The UE of claim 12, wherein:
the first transmit signal in the first transmit frequency band and the second transmit signal in the second transmit frequency band are attenuated prior to reception at the second antenna due to physical separation between the first antenna and the second antenna.
